(19) United States
(12) Patent Application Publication
(10) Pub. No.: US 2003/0030656 A1
(43) Pub. Date: Feb. 13, 2003

(54) Method and system for dynamic hierarchical data display

(76) Inventors: Darwin Ang, Gainesville, FL (US); Eric Poirier, Lake Butler, FL (US)

Correspondence Address: Christopher & Weisberg, P.A., Suite 2040, 200 East Las Olas Boulevard, Ft. Lauderdale, FL, 33301, US

(21) Appl. No.: 10/167,280

(22) Filed: Jun. 11, 2002

Related U.S. Application Data
(60) Provisional application No. 60/297,503, filed on Jun. 12, 2001.

(51) Int. Cl. G09G 5/00

(52) U.S. Cl. 345/700

(57) ABSTRACT

A system and method is provided for viewing hierarchical data on a portable computing device. The method and system provides for processing, organizing, and viewing hierarchically arranged data on a portable computing device display in a variety of embodiments. The system includes a central relational database for storing the source data, a data processing unit for converting the source data, and a text viewing software for multiple viewing platforms, including that of a personal digital assistant (PDA). The method disclosed provides for the processing of the source data, such as a medical text, into a relational database, and further processing of the database into platform-specific portable database files for viewing on a PDA. The data is arranged into a hierarchical data structure for dynamic viewing on a PDA display.

### CROSS-REFERENCE TO RELATED APPLICATION

This application is related to and claims priority to U.S. Provisional Application Serial No. 60/297,503, filed Jun. 12, 2001, entitled METHOD AND SYSTEM FOR DYNAMIC HIERARCHICAL DATA DISPLAY, the entirety of which is incorporated herein by reference.

### STATEMENT REGARDING FEDERALLY SPONSORED RESEARCH OR DEVELOPMENT

n/a

### FIELD OF THE INVENTION

The present invention relates to portable computing devices, namely, a method and system for processing, organizing, and viewing hierarchically arranged data on a portable computing device.

### BACKGROUND OF THE INVENTION

Access to information is crucial in the modem age. Yet, in addition to access, the mode of access as well as the manner in which the information is delivered is also critical to the exploitation of information for positive results. All too often, the information systems of today deliver vast amounts of data which is not properly organized, difficult to use, and inefficient in its practical application to problems.

Indeed, the organization of information is often more important to its efficient application than that of the actual content of such information. Information must be organized to allow a user to find not only answers to what he or she may be initially seeking, but to also allow a user to navigate the realm of information for answers to questions that he or she may not initially seek. Or even further, such organization may allow a user to find information on the so-called “serendipity principle,” whereby information which may be totally unrelated to the initial problem or area of concern may present itself to the user as desirable.

Most information systems of today utilize electronic and computing devices. Most such devices in turn use databases or other forms of electronic filing systems. Traditional databases are organized by fields, records, and files. A field is a single piece of information; a record is one complete set of fields; and a file is a collection of records. For example, a telephone book is analogous to a file. It contains a list of records, each of which consists of three fields: name, address, and telephone number. An alternative concept in database design is known as hypertext. In a hypertext database, any object, whether it be a piece of text, a picture, or a film, can be linked to any other object. Hypertext databases are particularly useful for organizing large amounts of disparate information.

Information is also commonly organized in a hierarchical manner, which refers to systems that are organized in the shape of a pyramid, with each row of objects linked to objects directly beneath it. Many databases and information systems have hierarchical structure. This is in contrast with other modes of organization, such as network or relational databases. Network databases use an organization method which allows for data relationships in a net-like form. A single data element can point to multiple data elements and can itself be pointed to by other data elements. Relational databases extend this principle even further, using an organizational method which links data elements based on a set of generalized criteria. The nature of information and the field in question often determines the kind of organization used for the information, and vice versa.

The information must also be easily used, in both time and location. Thus, in both the temporal and spatial sense, portability is a key aspect to the efficient use of information. Databases and other electronic filing systems are rapidly becoming more and more portable, using less and less space, and more efficient use of technology, such as dynamic memory allocation and data compression techniques. The portability of computing devices is thereby dramatically increasing the practicability of information retrieval.

The medical field is one area where information must be organized and used in an efficient a manner as possible. In addition, such information must be portable, so that a medical professional can easily use the information in a clinical setting. Therefore, portable computing devices functioning as information platforms carry great potential in the field of clinical medicine, or even in non-clinical settings. Up to now, most medical references have remained in paper form and have not yet been transferred to an electronic platform. Many commonly used medical reference guides are therefore still quite cumbersome to use, and relatively inaccessible to the medical professional. The need for a portable computing device which contains the medical information heretofore found only on paper is critical to moving the medical field forward in the information age.

One such portable computing device is the Personal Digital Assistant (PDA). PDAs have recently seen a great deal of commercial success, with sales of such devices growing exponentially in the last decade. PDAs are also rapidly becoming convenient and efficient tools for physicians and other medical professional. Especially in a clinical setting, the need for up-to-date, reliable, and easily accessible information is paramount. Furthermore, the required information must be portable, in that a user can easily carry the information-conveying device from one area to another with relative ease.

Yet, the most widely used PDA software applications in today's medical field were initially created by physicians for their own personal use. Most of these physicians and medical students had minimal programming skills and created these products out of curiosity rather than necessity. These products used the native gadgets and applications contained on the two most popular portable computing device operating systems available in today's market, the PALM® operating system and the POCKETPC® operating system.

Nevertheless, these efforts have not yet yielded a highly efficient and portable information delivery platform. Much of the difficulty lies in translating highly structured medical texts to the PDA platform. The size of most display screens are also necessarily limited on a PDA. Furthermore, the available native tools on the PDA also limit the ability to fully exploit the nature of medical information on a portable computing device. Medical texts in particular are filled with highly structured, graphical, and tabular information which is ill-suited to be handled by the native software applications in the primary portable computing devices in today's market.

It is highly desirable therefore, to provide a system and method for organizing, storing, and allowing users to retrieve information, such as those contained in medical texts, with portable computing devices such as the PALM® and POCKETPC®. Furthermore, since much of the needed information is hierarchical, it is desirable to provide a system and method which creates hierarchically organized data which may then be navigated dynamically by the user on the portable computing device, so as to best simulate the medical algorithm, that of using inductive and deductive reasoning to approach problems and to learn new information, even if serendipitously, while making the medical text a much more effective tool at the point-of-care.

### SUMMARY OF THE INVENTION

The present invention advantageously provides a method and system for processing, organizing, and viewing hierarchically arranged data on a portable computing device.

According to an aspect, the present invention provides a method of processing data to be viewed on a portable computing device. A source data is processed to produce a first relational database data. The first relational database data is processed to produce a second relational database data. The second relational database data is further processed to build a portable database data adapted to be rendered by the portable computing device. The portable database data is rendered and viewed on the portable computing device.

According to another aspect, the present invention provides a system for processing and viewing data, which includes a communication network, a first database including source data, a data processing unit coupled to the communication network, and a portable computing device coupled to the communication network. The first database is coupled to the communication network. The data processing unit processes the source data in the first database to produce portable device database data. The portable computing device is adapted to display at least a part of the portable device database data.

According to yet another aspect, a method is provided for using hierarchical data on a portable computing device. A source data set is transformed into a first database data. The first database data is arranged in a relational database using a first hypertext mark-up language. The first database data is processed to produce a second database data. The second database data is arranged in a secondary database using a second hypertext mark-up language. The second database data is processed to produce a portable database file. A viewer is produced which is adapted to process the portable database file for viewing on a portable computing device. The viewer and portable database file are transmitted via a communications network to a portable computing device.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is diagram of the components of a network corresponding to a first embodiment of the present invention;

FIG. 2 is a block diagram of a portable computing device constructed in accordance with the first embodiment of the present invention;

FIG. 3 is a view of a front face of the portable computing device of FIG. 2;

FIG. 4 is a flowchart showing a data process in accordance with a system and method of the present invention;

FIG. 5 is a flowchart showing an alternate data process in accordance with a system and method of the present invention;

FIG. 6 is an example of hierarchical source data processed by a system and method of the present invention;

FIGS. 7A-7D are views of hierarchical data processed by a first embodiment of the system and method of the present invention and as displayed on a portable computing device display screen; and

FIGS. 8A-8E are views of hierarchical data processed by a second embodiment of the system and method of the present invention and as displayed on a portable computing device display screen.

### DETAILED DESCRIPTION OF THE INVENTION

As used herein, a “computer” (or “computing device”) shall mean a programmable machine which responds to a specific set of instructions in a well-defined manner and can execute a prerecorded list of instructions, such instructions being a software “program.” As used herein, “software” shall mean any computer instructions or data, or anything that can be stored electronically. Also as used herein, “script” shall mean another term for macro or batch file, wherein a script is a list of commands that can be executed without user interaction, with a script language being a simple programming language with which one can write scripts. Also as used herein, “hyperlink” shall mean an element or object in an electronic document that links to another place in the same document or to an entirely different document.

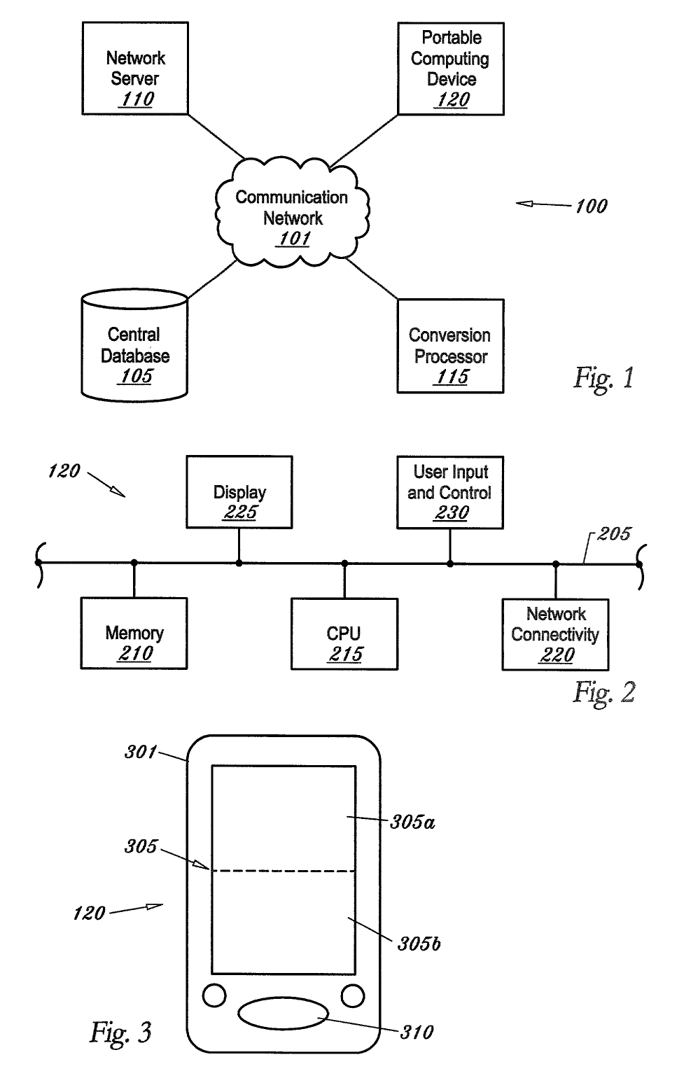

Turning now to the drawing figures in which like reference designators refer to like elements, there is shown in FIG. 1 a network of databases and computing devices assembled in accordance with a first embodiment of the present invention and designated as system 100. System 100 includes a central communication network 101, one or more central databases 105, one or more network servers, one or more conversion processors 115, and one or more portable computing devices 120. Communication network 101 may be any data communication facility suitable for allowing a group of two or more computers to communicate. Network 101 may be a local area network (LAN) spanning a relatively small area, or confined to a single building or group of buildings. Or, one LAN can be connected to other LANs over any distance via wires and/or radio waves to constitute a wide-area network (WAN). Or, network 101 may form part or all of a worldwide global communications system, such as the Internet. Communication network 101 may support or function with a number of communications protocols such as Transmission Control Protocol/Internet Protocol (TCP/IP).

One or more central databases 105 are connected to the communications network 101. Each database 105 is equipped with a database management system (DBMS). The DBMS may take any form such as relational, flat, network or hierarchical, and may support different query languages, including semi-standardized query languages such as structured query language (SQL), as well as more sophisticated fourth-generation languages for managing database systems.

A network server 110 and conversion processor 115 are also connected to communications network 101 and form part of the system of the present invention. Network server 110 includes some or all of the data files derived from the data resident in central database 105, allowing users to download such files to their own computers via network 101. The conversion processor 115 is a computing unit which transforms central database 105 data to usable and downloadable files to be placed in network server 110. Network server 110 may be an electronic commerce website on the Internet, or may be a more generalized file or application server connected to a more limited local network such as an intranet. Network server 110 may also contain the central database 105, or may be linked to such database as part of a stand-alone computing device, with each component being directly linked to the other component independent of the communication network.

Conversion processor 115 is arranged as a general data processing unit and may be any computing device capable of reading data from the central database 105 and an executing a program written in a known programming language such as C++. Conversion processor 115 may be a microcomputer such as a MacIntosh or IBM PC compatible, a UNIX-based microcomputer or mini-computer, and/or a main frame computer and the like.

Although not specifically shown in FIG. 1, each of conversion processor 115, central database 105, and network server 110 may include one or more of a display screen such as a color monitor, a keyboard for entering data and commands, a pointing device such as a mouse for pointing and for manipulating objects depicted on the display screen, a mass storage device for storing the computer operating system, such as DOS or UNIX, the database system, the networking application program, or the mainframe terminal emulation application program, as the case may be, and as is well known to those skilled in the art.

Although not specifically shown in FIG. 1, each of conversion processor 115, central database 105, and network server 110 may also include a floppy disk drive interface into which floppy disks may be inserted, optical data storage device, or other removable data storage device. Information from such removable data storage devices may be downloaded into the mass storage device. Such information may include data files, application programs, utilities, and database management systems. The components of system 100 may also include network interface hardware, such as a local area network interface hardware, serial data communications hardware, or parallel data communications hardware. Such network interface hardware is used to transfer executable and nonexecutable files between the various devices which make up system 100, as well as any additional devices which may be connected thereto.

Although server 110, central database 105, conversion processor 115 are shown as three separate devices in FIG. 1, it is contemplated that these devices can be implemented as three or fewer devices. As is more specifically described below, data in the central database 105 is processed and converted by the conversion processor 115 and placed onto the network server 110. A user connected to the network 101 may then obtain the processed data for use in the portable computing device 120.

A block diagram of the portable computing device 120 is shown in FIG. 2. As shown in FIG. 2, portable computing device 120 includes a central processing unit 215 (hereinafter ““CPU”) interfaced with a computer bus 205. Also interfaced with the computer bus 205 is a network interface 220, a display interface 225, a user input and control interface 230, and a main memory 210. Although not shown in FIG. 2, the portable computing device 120 may also be equipped with a pointing device interface, a floppy drive interface, a storage disk, and a printer interface. Memory 210 may include both random access memory as well as read-only memory for storage of applications and data transferred from the central database 105 of FIG. 1. Main memory 210 is interfaced with the computer bus 205 to provide random access memory (RAM) storage for use by the CPU 215 when executing stored program instructions. More specifically, the CPU 215 loads those programs from the storage disk, from a floppy disk in the floppy disk drive interface, or from the network via the network interface 220 into main memory 210, and executes those stored programs out of main memory.

FIG. 3 shows a physical representation of the front face of a first embodiment of a portable computing device arranged in accordance with the principles of the present invention. Portable computing device 120 includes a body 301, a display 305, and a user input and control interface 310. The display 305 may be a unitary screen or raster, or may be subdivided into one or more screens, such as an upper screen 305a and a lower screen 305b. The combination of display 305 and input and control interface 310 may be more conveniently identified as the general “display interface”, since the display 305 may be a touchscreen display adapted to receive user inputs through a tap on the screen.

The portable computing device 120 may be a PDA. Commercial examples of portable computing devices 300 arranged in accordance with the principles of the present invention are the PALM® and PCOKETPC®. By no means however, is the present invention limited to such platforms. Indeed, as will be more specifically described below, the present invention's system and method may be applied to any portable computing device that includes the primary components illustrated in each of FIGS. 2 and 3. As used herein, “portable” shall mean relatively small and lightweight, such that the object in question may be easily held in one hand, and carried without undue effort, and preferably having a weight of under 5 pounds.

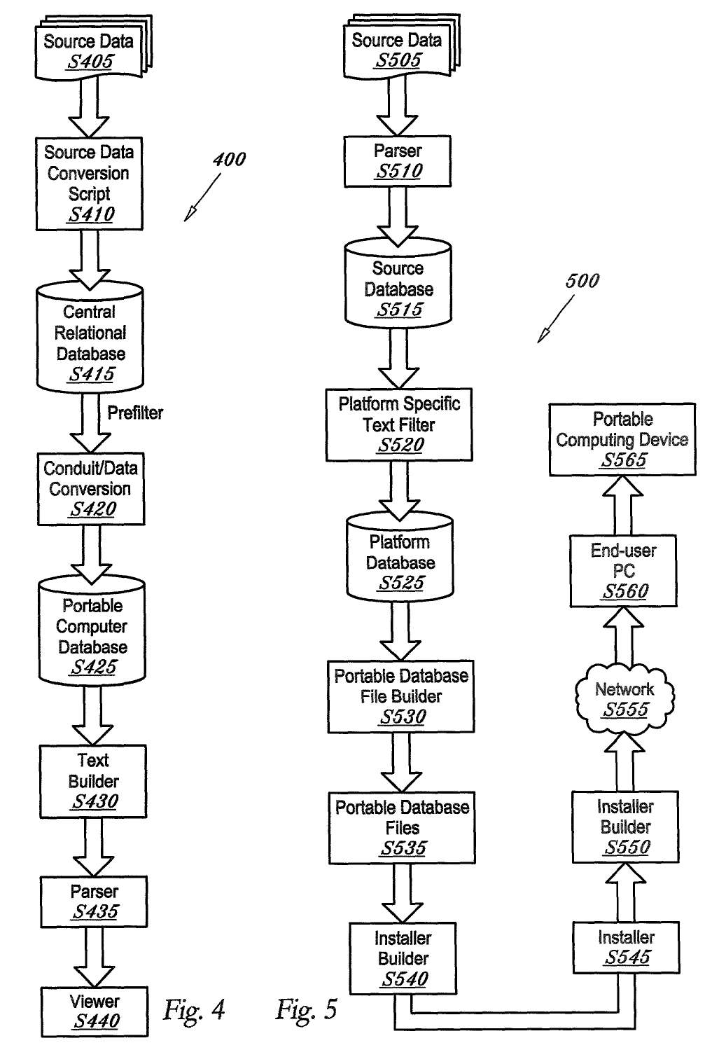

FIG. 4 is a flowchart showing a data process in accordance with the system and method of the present invention. The present invention advantageously transforms data and information to be used on a portable computing platform, with medical data being a first embodiment of a particular kind of information concerned. FIG. 4 illustrates the process accomplished by the system and method of the present invention, and is labeled generally as process 400. The elements discussed and illustrated in process 400 constitute the primary, basic level components of the method of the present invention, and are executed by one or more elements of the network system shown in FIG. 1, and/or the portable computing device shown in FIG. 2.

The process begins with step S405, where the source data to be processed is identified. By way of example, the source data in this case is medical data from one or more medical references, such as the “Sanford Guide to Antimicrobial Therapy.” The data in this case is hierarchical in nature, whereby one or more objects is related to one so-called “parent” in a pyramidal, hierarchical structure. The objects in question are data which is organized in tables, and has the characteristic hierarchal organization found in most medical texts. The data need not be hierarchical however. In many cases, the data may indeed not be hierarchical in nature, such as a list of definitions or other serial arrangement of data, such as a dictionary.

The source data is first compiled into a parsable format in step S410. In some cases the data may be parsable by certain characters, such that it is compiled as a character separated database table. Examples of commonly used characters are commas or periods. In other cases the parsable format is an Extensible Markup Language (XML) or HyperText Markup Language (HTML) representation of the original source data. The particular parsable format is in part dictated by the nature of the source data, the manner in which it is originally formatted, and the ease by which it may eventually be parsed and entered in the relational database. A script is then used to parse the data file as an input. The parsing script inserts the resultant parsed-data in a central relational database in step S415. The parsing script may be a Practical Extraction and Report Language (PERL) script, or any other script using a language designed for processing text, or any script particularly suited for accomplishing the task of transforming the source data into a relational database.

Step S415 also includes a “pre-filtering” script which is applied to the data from the central relational database. This pre-filtering “conditions” the data stored in the central relational database such that the resultant data is more specifically geared to the portable computing platform in step S425. Examples of such conditioning are the filtering of certain characters which may not be properly displayed by the particular portable computing platform in question. Thus, once the first relational database is built, a filter generates a second relational database which contains platform specific data. Each of such relational database are represented as the relational database “stage” of step S415 shown in FIG. 4.

The aforementioned central relational database preferably uses a version of a structured query language (SQL), such MySQL, as its relational database management system. Other equally suited database management systems may be used. Regardless of the database management system used, the database tables contained in the central relational database may be read by the conduit and data conversion unit in step S420 by an Open DataBase Connectivity (ODBC) connection, such that it is possible to access any data from the central relational database S415 regardless of which database management system is actually handling the data. In step S420, the conduit and data conversion unit corresponds to the conversion processor 115 illustrated and shown in FIG. 1.

During the conduit and data conversion step S420, the conversion processor 115 (i) reads the data from the central relational database through an ODBC connection with the central database, (ii) interprets the data, converting the HTML tags to new tags using a customized subset of HTML, labeled “BCEML”, and filters the text, and (iii) creates the databases to be used and stored in the portable computer database in step S425. “BCEML” is a subset of HTML, containing certain tags used to render the text specially formatted for portable computing devices 300. As used herein, a “tag” shall mean any command inserted in a document that specifies how the document, or a portion of the document, should be formatted. The document in this case is any portion of the data viewed on the portable computing device 300. BCEML includes special tags for bolding and un-bolding text, italicizing and un-italicizing text, indenting and un-indenting text, opening and closing hyperlinks, and breaks to the next line of text.

The “data” being processed by the conversion processor 1 5 in step S420 is the source data resident in the central relational database. This data largely corresponds to the tables in the relational database. It may also however, contain additional data required to effect the processing in step S420. The conversion processor 115 utilizes a conversion program that converts and filters the data from the central relational database to create a new portable computer database. The new portable computer database is compatible with the particular operating system resident on the portable computing device or computer 120. One aspect of step S420 is to produce a new set of database data that is easily read by the relatively slower processors found in most portable computing devices, such as to create a new set of text tags that are limited in number to less than those used in convention markup languages like HTML, have fewer characters, and hence may be read and processed faster by portable computing device or computer 120.

The filtering process outlined above in step S420 may have also been accomplished in step S410 when the central relational database is created in step S415. In either case, the original source data is marked up and tagged to uniquely suit the characteristics and requirements of the portable computing platform to be used. The end result is that in step S425, a new portable computer database file is created by the conversion processor 115.

In step S420, a software program is used to execute the process of marking up the data from the central relational database. This program also performs a particular conversion for data that is to be used on a portable computing operating system that does not handle the conventional unique identifier codes found in most database records and data. Certain such portable computer operating systems may lack the specific functionality built in to their application program interfaces to handle unique identifiers for each record in a database. For such a platform, a sequential index is commonly used instead of the unique identifier. Thus, the data conversion step in S420 converts all unique identifiers found in the data from the central relational database to sequential indices for use in the portable computing device. One example of a portable computing device that requires such sequential indexing is a device which uses the PalmOS® operating system.

First, a map is built between the unique identifier on the central relational database and the sequential index used in the portable computing database. For each record, the map constitutes a one to one relationship for each of the unique identifiers on the central relational database and its corresponding index in the portable computer database. Each of the foregoing conversions from unique identifiers to sequential indices is executed for each record in the data derived from the central relational database.

The new portable computer database is then stored in a new, downloadable file. This file may be deliverable to an end-user or customer, as the case may be, via any readily used means of communication. The portable database files include a header plus data in record form. Each record may have an arbitrary size, within a certain predetermined maximum, and may contain data in any format, such as text or video data.

Once the portable database file is delivered to the portable computer, additional software loaded onto the portable computer is used to render and view the data contained in the portable database file on the portable computing device. In step S430, the text builder program reads records from the portable database file and creates a hierarchy for the data therein, in BCEML, using an algorithm to arrange the hierarchy into a conventional genealogical structure. To display a particular target record, each target record is displayed in a genealogical tree with its eldest ancestor record, parent records connecting the target record to the ancestor, sibling records, and all children of the target record. The text builder, or “hierarchy builder”, produces the desired output using tags derived from the customized BCEML markup language, to create objects such as hyperlinks, bolded text, and the styled formatting to be viewed on the display of the portable computing device. For each record in the portable computer database file, the text builder builds the hierarchy by assigning a “parent” pointer and a “child” pointer to each record. Each record may then be easily linked to either its parent in the hierarchical tree, or to its child. The parent pointer is null for those records at the top, or highest level, of the hierarchy tree. Furthermore, once a child link is tapped, the child pointer in each record allows the program to retrieve all records linked below the record as “children” of such a record. Furthermore, each of the pointers used as such includes either the unique identifiers or the sequential indices, as discussed above, that are used with each record depending on the portable computing platform onto which the portable computer database is to be placed. This forms the hierarchical linkages in all the records.

The text builder itself consists of three routines. The first routine produces a list of the top level of the hierarchy applied to the data. Each item in the list is a hyperlink. If such hyperlink is tapped on, the list will expand under such item to show the levels beneath, in accordance the overall hierarchical structure of the data. The second routine is applied to build the hierarchy tree itself. The second routine handles all of the indentation and bulleting used in many hierarchical tree layouts, and uses the recursively implemented algorithm described above to arrange the genealogical hierarchy. The third and final routine in the text builder displays the last, or lowest level, item in a tree in a specified format.

Once the text building routines are accomplished in step S430, a parser parses and interprets the data from the portable computing database and creates a viewer friendly output. The parser and viewer work together to render formatted text on the portable computing device screen. For example, the viewer may draw the screen character by character, using three state variables, one each for the row or vertical position, column or horizontal position, and font or format of each character. The parser works with the viewer by scanning the source text for tags, with each tag potentially changing the state of each variable in the viewer.

Finally, in step S440 the viewer program renders the data to be displayed on the display of the portable computing device. The viewer is a component with the application software resident in the portable computing device. The viewer converts the BCEML data produced by the text builder into formatted text and renders the text on the portable computing device's screen. The viewer also handles user input into the portable computing device, such as button and hyperlink taps. In such a case, the process in FIG. 4 is looped back to step S430, wherein the tap of a hyperlink during viewing will generate a link retrieval event. In such a case, the viewer passes a hyperlink to the text builder and the text builder processes the link and returns a buffer containing the BCEML text. All of steps S430 through S440 occur during runtime on the portable computing device.

FIG. 5 illustrates another view of a data process in accordance with the system and method of the present invention, the entire process being designated generally as 500. The process starts at step S505 with the source data. The source data can be any parsable data, and generally may begin as HTML, or comma separated data, or the like. In the context of the medical field, the source data is a medical text or series of documents, much of which is in tabular form. However the system and method of the present invention are not limited to such data, nor are they strictly limited to medical data. Medical texts and the processing of such texts are but one embodiment of the application of the system and method of the present invention. One of ordinary skill in the art will easily appreciate that the system and method described herein may be applied to many texts in various fields, and is not strictly limited to medical texts.

Next, in step S510, a parser converts the source data into a relational database. The process embodied in step S510 both creates the database tables, and fills the tables with data and records gleaned from the source data, in this case a medical text. The result is a data set stored as a relational database, this database being the initial “source” database, preferably managed by a structured query language database manager such as MySQL, in step S515.

The application data parsed from the source documents in step S510 is initially stored in the source database in step S515. The data in the source database is initially represented in a universal form. The data will eventually be processed to be loaded and viewed on a computing platform. Examples of such platforms are: (i) on the Internet on a website, (ii) on a PDA, or, (iii) on a personal computer. In the case of the PDA, two particular commercially used platforms are the PalmOS® and the PocketPC® based platform. However, in order to allow the platform to handle the data, the source database must at first be filtered to render it compatible with the particular platform.

In step S520, a platform specific text filter creates a separate database that is uniquely catered to the particular characteristics of the computing platform desired. Special characters, such as the “⅓” character, are converted to the equivalents used by the platform operation system. Errors are checked and corrected; links are matched; invalid characters are deleted; and a general hierarchical structure is created. The eventual result is the creation of a platform-specific database in step S525. All of the foregoing elements, programs, and databases may reside in one or more computers or servers, such as the network server 110 of FIG. 1, connected to the communications network described above.

Next, the platform database is used to create portable computer database files by the portable database file builder program in step S530. This is accomplished by the conversion processor 115 of FIG. 1 and corresponds to the data conversion step S420 discussed with regard to FIG. 4. This results in the creation of a portable database file for distribution to the end-user. Next, in step S540, an installer-builder program is also executed to create and installer executable file in step S545. The combination of the portable database file created in step S535 and the installer executable file created in step S545 is thus to be bundled and used by the end-user on their particular computing platform. An example of the installer-builder suitable for use in this process is Installshield.

The installer and database files are placed on a network server 110 which may be an electronic commerce website, as in step S550. In step S555, an end-user may then download the files through a network, such as communication network 101 displayed in FIG. 1, to obtain and store the data onto his or her computer in step S560. Finally, in step S565, the end-user may transfer the files to portable computing device 120 for rendering and viewing thereon in accordance with the system and method described herein.

Thus, the overall process illustrated in FIG. 5 transforms the source data to a format ideally suited to rendering and viewing on a portable computing device. In many cases, the data may be hierarchical in nature. Thus, the hierarchy must be preserved and presented on portable computing device, while maintaining the integrity of the information contained in the source data.

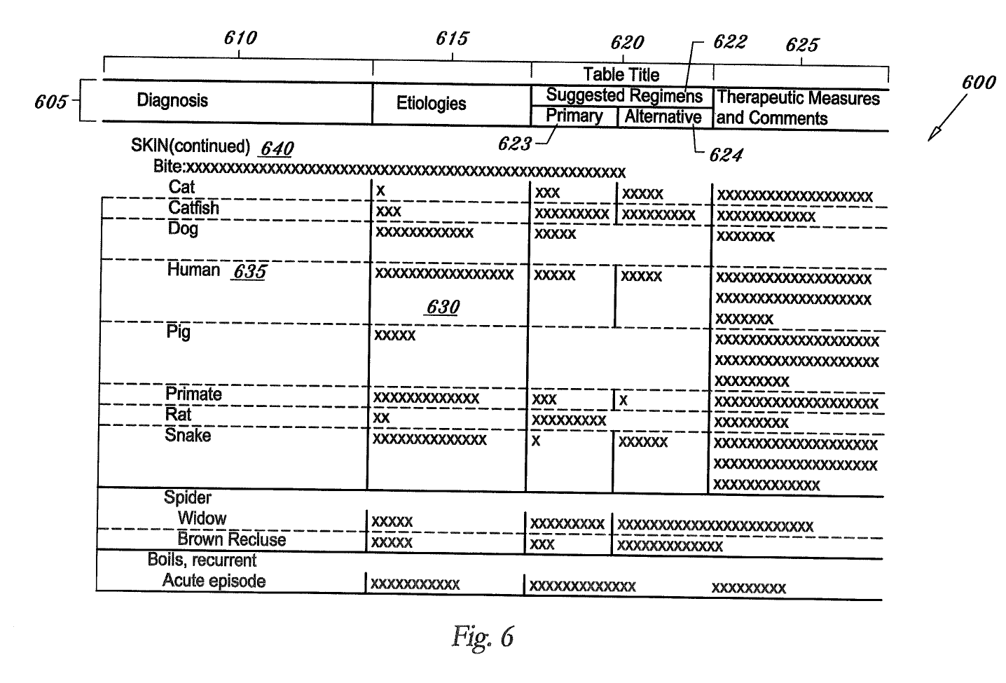

FIG. 6 illustrates one example of the source data which may be processed by the system and method of the present invention. In FIG. 6, there is shown a table representative of a typical medical diagnostic text, and designated generally as 600. Table 600 includes a main header row 605, and a series of columns 610, 615, 620, and 625, in which various data entries are arranged in table cells of which cell 630 is one. Cell 630 corresponds to the reference of a row designated under a particular category 635, that of “human”, and a column designated under the category 615, that of “etiologies”, as shown in FIG. 6. It is appreciated that the nature of the table is complex in that certain cells may span multiple rows and/or columns, and indeed, that the columns themselves may be split, as in column 620 being split into subcategories 622, 623, and 624.

However, regardless of the complex nature of the information and how the information is organized in table 600, a certain hierarchical structure exists. Generally, the primary category utilized in deriving information from the table is the left-most column 610. After choosing a particular item in such a category, the user may proceed to alternate columns and focus on a particular cell. The hierarchy is thus dictated by the layout of the information in the columns and rows.

It will be appreciated however, that the size and layout of table 600 may not be suited for viewing on a limited display screen of a portable computing device. Thus, table 600 must be parsed and reorganized, while retaining its overall fundamental hierarchy, to be displayed on a smaller, more compact viewing area. This is precisely the step accomplished by the source data conversion script in step S410 and conduit and data conversion unit in step S420 of the process illustrated in FIG. 4, and as elaborated above. Each cell is first reorganized in tables in the central relational database. Then the central relational database tables are reformatted and placed in portable computing device platform database files, upon such files are rendered and viewed by the executable text builder-parser-viewer program on the portable computing device or computer 120.

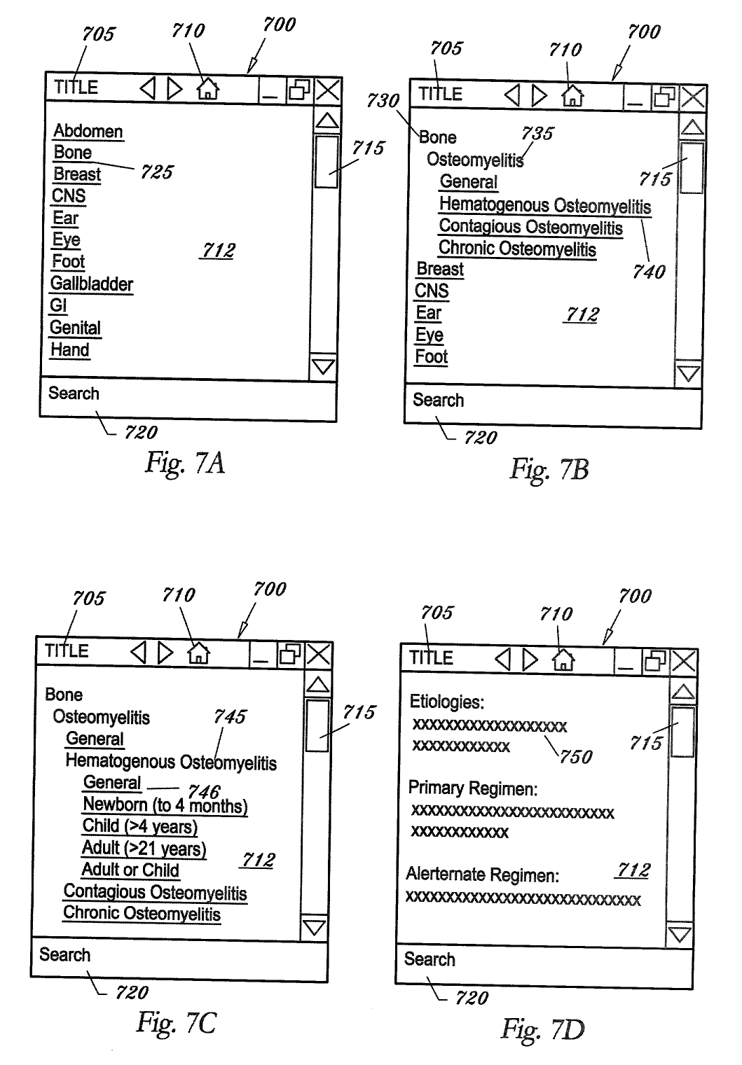

FIGS. 7A-7D illustrate an embodiment on a display screen 305 of portable computing device 120, a number of views of the source data after it has been processed by the system and method of the present invention. The particular format shown is in accordance with, among other platforms, the PalmOS® operating system. Each “screenshot” 700 includes a title bar 705 with control buttons 710, a main window 712 with scroll bar 715, and a search window 720. Within the main window lie the primary category of data items 725, representing the highest level of the hierarchy. This level is analogous to the leftmost column of data organized in the table 600 of the source data. In FIG. 7B, a particular item in the primary category, “bone” 730 has been selected. In this embodiment, an underline-formatted item represents a hyperlink, while a non-underline formatted item is no longer a hyperlink. However, each hyperlink is a link to additional data such as a table, or the set of records below the data item in the hierarchy. When, as in FIG. 7B, the “bone” item is selected or “tapped,” the hyperlinked reference causes the records linked to “bone” to appear and expand thereunder on screen. A secondary category appears, one item 735 of which is “osteomyelitis.” Further beneath such secondary category may be a tertiary category, each item of which may be hyperlinked. The hierarchy thus continues along each category, with each item in a each category being potentially hyperlinked to another item in another category. As shown in FIG. 7C, an item 740 in the tertiary category, “Hematogeneous osteomyelitis” has been selected to reveal its hyperlink, which includes yet another subcategory of items. Finally, the hierarchy may be exhausted in that an item in the final category may be selected, such as item 746 “General/Hematogeneous Osteomyelitis/Osteomyelitis/Bone”. Its hyperlink thus reveals a field of data which may correspond to any of the various fields or cells originally arranged in the source data table 600.

Each of the data items 725 represents a record, which may or may not be part of a table of records. The overall arrangement of all the data items 725 is that of a hierarchical data structure analogous to a “pyramidal tree.” In essence the data structure is akin to that of a classic hierarchy, where for each record, there exists one or more records one level lower down the hierarchy. The totality of records forms a tree-like structure, having an overall shape that is pyramidal in nature, with a number of successively lower levels. Within the data structure, a transition may generally made from one record to another in one of three directions. A “forward” directional movement corresponds to moving from one record to any one of its records linked thereto in the next successive “lower” level in the hierarchy. A “backward” directional movement is the reverse of a forward movement. And a “lateral” directional movement is a transition from one record to another record that resides in the same level of hierarchy.

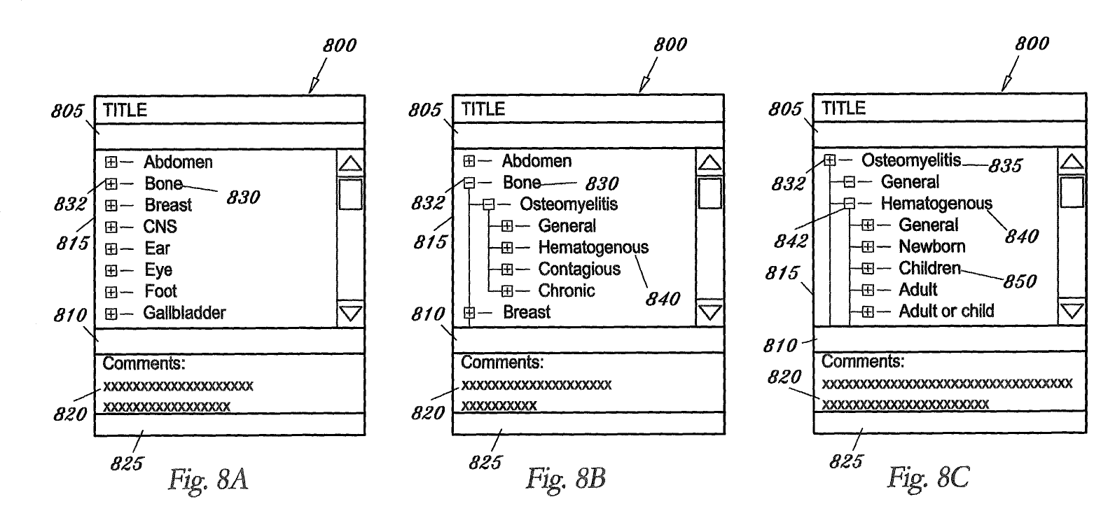

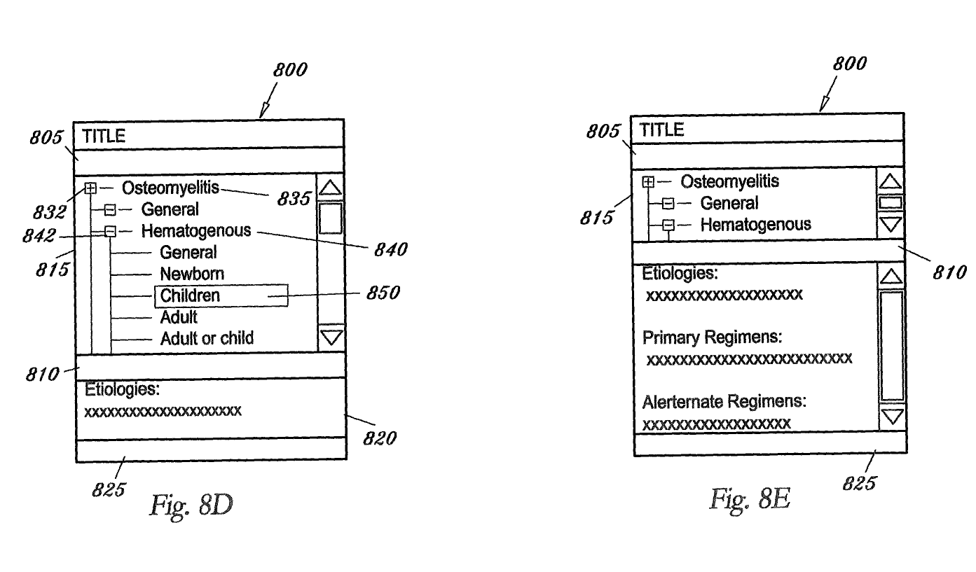

FIGS. 8A-8E illustrate another embodiment on a display screen 305 of portable computing device 120, a number of views of the source data after it has been processed by the system and method of the present invention. The particular format shown is in accordance with, among other platforms, the PocketPC® operating system. In this embodiment, each “screenshot” 800 includes a title bar 805, splitter bar 810, main window 815, second window 820, and a list of items 830 with expansion/contraction icons 832 situated in the main window 815. An additional menu bar 825 may be included as shown. This embodiment does not utilize hyperlinked items in the hierarchy tree displayed in the main window 815, but rather utilizes expansion/contraction icons 832 to the left of each item. A “+” sign indicates an item is hyperlinked to a set of records or new subcategory, which may be expanded, or shown, when tapped. While a “−” sign indicates that such subcategory is already displayed and may be contracted, or hidden, when selected. The overall arrangement of primary items, such as 830 can be expanded to secondary items 835 (along with its expansion/contraction icon 837), tertiary items 840 (along with its expansion/contraction icon 842), and final items 850 in the hierarchy similar to that of the embodiment shown in FIGS. 7A-7D.

The primary difference with this embodiment is the vertically moveable scrolling splitter bar, which allows a user to adjust the relative sizes of the main window 815 and second window 820. The second window contains the field data for each of the items selected in the hierarchy. When desired, the user may expand the size of second window 820, to reveal more of such field data, as illustrated in FIG. 8E. The arrangement of dual windows allows a user to freely navigate the hierarchy while reading the field data associated with any item in hierarchy.

The system and method of the present invention thus advantageously provides a unique, dynamically functioning, hierarchical display for viewing complex, tabular and hierarchical data on a portable computing device. Given the particular hierarchical and tabular organization of medical information, the system and method is thus uniquely suited to viewing such medical information on a portable computing device.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of processing data to be viewed on a portable computing device, the method comprising:
processing a source data set to produce a first relational database data;
processing the first relational database data to produce a second relational database data;
further processing the second relational database data to build a portable database data adapted to be rendered by the portable computing device;
rendering and viewing the portable database data on the portable computing device.

2. The method of claim 1, wherein the portable database data comprises hierarchical data.

3. The method of claim 2, wherein the source data set is a medical text.

4. The method of claim 1, further comprising:
producing an installer to install an executable program on the portable computing device;
transmitting the portable database data to the portable computing device;
transmitting the executable program via a communications network to render and view the portable database data file on the portable computing device; and
storing the portable database data in a memory in the portable computing device.

5. The method of claim 4, wherein the portable database data comprises hierarchical data, and wherein the hierarchical data is organized into a plurality of categories in hierarchical form.

6. The method of claim 5, wherein the source data is a medical text.

7. A system for processing and viewing data, the system comprising:
a communication network;
a first database including source data, the first database coupled to the communication network;
a data processing unit coupled to the communication network, the data processing unit processing the source data in the first database to produce portable device database data; and
a portable computing device coupled to the communication network, the portable computing device being adapted to display at least a part of the portable device database data.

8. The system according to claim 7, further including a server in communication with the communication network, the server including the platform-specific database data;

9. The system of claim 8, wherein the source data is a hierarchically organized medical text.

10. The system of claim 9, wherein first database is a relational database.

11. The system of claim 10, wherein the portable computing device is a personal digital assistant, and the portable device database data is adapted to be readable by the personal digital assistant.

12. The system of claim 11, wherein the portable device database data is a set of hierarchically organized records corresponding the hierarchically organized medical text.

13. The system of claim 12, further comprising an executable program for rendering and viewing the portable device database data on the portable computing device, the executable program being adapted to be executed by the portable computing device.

14. The system of claim 13, wherein the portable computing device further includes a display, and wherein the executable program enables a user of the personal digital assistant to dynamically navigate through the set of hierarchically organized records on the display.

15. A method of using hierarchical data on a portable computing device, the method comprising:
transforming a source data set into a first database data;
arranging the first database data in a relational database using a first hypertext mark-up language;
processing the first database data to produce a second database data;
arranging the second database data in a secondary database using a second hypertext mark-up language;
processing the second database data to produce a portable database file;
producing a viewer adapted to process the portable database file for viewing on a portable computing device; and
transmitting the viewer and portable database file via a communications network to a portable computing device.

16. The method of claim 15, wherein the portable database file includes a hierarchical data structure corresponding the source data.

17. The method of claim 16, wherein the source data is a medical text arranged as a plurality of tables, each of the plurality of tables having one or more records, each of the one or more records in each of the plurality of tables having a data field, the combination of tables, records and data fields corresponding to the hierarchical data structure.

18. The method of claim 17, further comprising
dynamically navigating the hierarchical data structure through the display interface of the portable computing device, wherein the hierarchical data structure includes a pyramidal tree having a plurality of records, each record having a data.

19. The method of claim 18, further comprising
dynamically navigating through the pyramidal tree of records in a forward, backward, or lateral direction.

20. The method of claim 19, and further including:
displaying a portion of the pyramidal tree in a first display window, and
displaying a portion of the data corresponding to a record in the pyramidal tree in a second display window.
